(19) United States
(12) Patent Application Publication
(10) Pub. No.: US 2023/0307178 A1
(43) Pub. Date: Sep. 28, 2023

(54) SOFT MAGNETIC BODY, MAGNETIC CORE, AND ELECTRONIC COMPONENT

(71) Applicant: TDK CORPORATION, Tokyo (JP)

(72) Inventors: Kenichiro MATSUNO, Tokyo (JP); Mamoru ITO, Tokyo (JP); Hiroshi HARADA, Tokyo (JP); Yoshitaka SHIBUYA, Tokyo (JP); Takayuki MIURA, Tokyo (JP); Naoki ITO, Tokyo (JP)

(73) Assignee: TDK CORPORATION, Tokyo (JP)

(21) Appl. No.: 18/178,834

(22) Filed: Mar. 6, 2023

(30) Foreign Application Priority Data
Mar. 28, 2022 (JP) 2022-051538

(51) Int. Cl. H01F 41/02; H01F 1/24; H01F 27/255; H01F 1/33

(52) U.S. Cl. CPC H01F 41/0246; H01F 1/24; H01F 27/255; H01F 1/33

(57) ABSTRACT

A soft magnetic body includes soft magnetic particles containing an element M and an intergranular region that exists between the soft magnetic particles and covers an outer periphery of the soft magnetic particles. On a cross-section of the soft magnetic body, a ratio of the element M at the center of the soft magnetic particles to a ratio of the element M in a soft magnetic composition that constitutes the soft magnetic body is within a range of 10% to 70%. On the cross-section of the soft magnetic body, an average of peripheral lengths of a plurality of the intergranular regions existing at the periphery of the soft magnetic particles is within a range of 5 μm to 15.5 μm.

### BACKGROUND OF THE INVENTION

### 1. Field of the Invention

The present invention relates to a soft magnetic body that is obtained by press-molding, for example, soft magnetic particles and subjecting the resultant press-molded body to a heat treatment, and a magnetic core and an electronic component which include the soft magnetic body.

### 2. Description of the Related Art

A metal magnetic material has an advantage that a higher saturation magnetic flux density is obtained in comparison to ferrite. As the metal magnetic material, an Fe—Si—Al based alloy, an Fe—Si—Cr based alloy, and the like are known.

For example, in JP 2020-038923 A, a soft magnetic composition in which a maximum value of a mass ratio of silicon to an element such as chromium and aluminum in a region between soft magnetic alloy particles is set within a specific range is developed, and a core loss is effectively reduced.

In recent years, in a soft magnetic body that contains an element such as chromium and aluminum, an improvement of DC bias characteristics becomes a problem to be solved.

### CITATION LIST

Patent Document
Patent Document 1: JP 2020-038923 A

### SUMMARY OF THE INVENTION

The present invention has been made in consideration of such circumstances, and an object thereof is to provide a soft magnetic body, a magnetic core, and an electronic component which are capable of improving DC bias characteristics.

To accomplish the above-described object, according to the present invention, there is provided a soft magnetic body including:
soft magnetic particles containing an element M; and an intergranular region existing between the soft magnetic particles and covering the soft magnetic particles.

On a cross-section of the soft magnetic body, a ratio of the element M at the center of the soft magnetic particles to a ratio of the element M in a soft magnetic composition that constitutes the soft magnetic body is within a range of 10% to 70%.

On the cross-section of the soft magnetic body, an average of peripheral lengths of the intergranular regions existing around each of the soft magnetic particles is within a range of 5 μm to 15.5 μm.

The present inventors and the like have made a thorough investigation on an improvement of DC bias characteristics of the soft magnetic body. As a result, they obtained the following finding. Specifically, it is important that the ratio of the element M at the center of the soft magnetic particles is within a specific range and the peripheral length of the intergranular region of the soft magnetic particles is within a specific range, and they have accomplished the present invention.

Preferably, the element M contains at least one or more elements of which ionization tendency is larger than ionization tendency of Fe and Si.

Preferably, a ratio of the element M contained in the intergranular regions is higher than a ratio of the element M at the center of the soft magnetic particles.

Preferably, a ratio of Si contained in the intergranular regions is higher than a ratio of Si at the center of the soft magnetic particles.

According to another aspect of the present invention, there is provided a magnetic core including the soft magnetic body according to any one of the above-described items.

According to still another aspect of the present invention, there is provided an electronic component including the soft magnetic body according to any one of the above-described items.

### BRIEF DESCRIPTION OF THE DRAWINGS

FIG. 1 is a schematic perspective view of a magnetic core including a soft magnetic molded body according to an embodiment of the present invention;

FIG. 2A is an enlarged view of a partial cross-section of the magnetic core shown in FIG. 1;

FIG. 2B is a photomicrograph of a partial cross-section of a magnetic core according to Example of the present invention;

FIG. 2C is a photomicrograph of a partial cross-section of a magnetic core according to Comparative Example of the present invention;

FIG. 3A is a schematic view showing an inscribed circle and a circumscribed circle of the soft magnetic particles shown in FIG. 2A;

FIG. 3B is a captured image obtained by enlarging the photomicrograph shown in FIG. 2C and writing the inscribed circle and the circumscribed circle of the soft magnetic particles;

FIG. 4 is a captured image obtained by enlarging the photomicrograph shown in FIG. 2C and writing circumscribed circles to ten soft magnetic particles adjacent to each other; and

FIG. 5 is a captured image showing measurement sites of an in-grain region and an intergranular region of particles by enlarging a part of the photomicrograph shown in FIG. 2B.

### DETAILED DESCRIPTION OF THE PREFERRED EMBODIMENTS

Hereinafter, an embodiment of the present invention will be described with reference to the accompanying drawings.

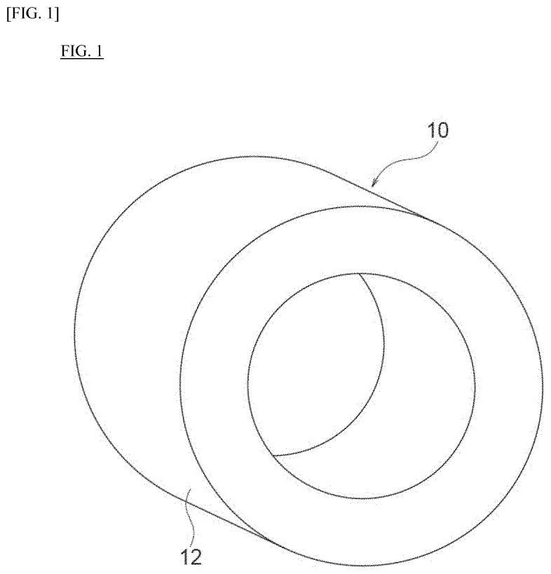

As shown in FIG. 1, a magnetic core 10 according to this embodiment includes a soft magnetic molded body 12 that is molded in a toroidal shape. The shape of the magnetic core 10 is not particularly limited, and examples thereof include an FT type, an ET type, an EI type, a UU type, an EE type, an EER type, a UI type, a drum type, a pot type, a cylindrical type, a prism type, and the like in addition to the toroidal type. A single or a plurality of wires or the like are wound around a part of the magnetic core 10 to be used as an electronic component or the like of a coil device or the like.

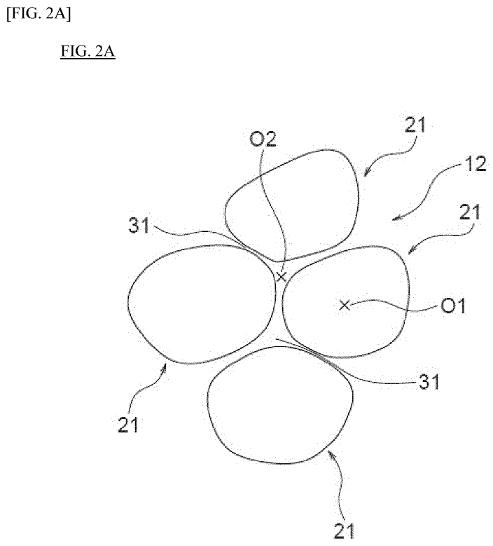

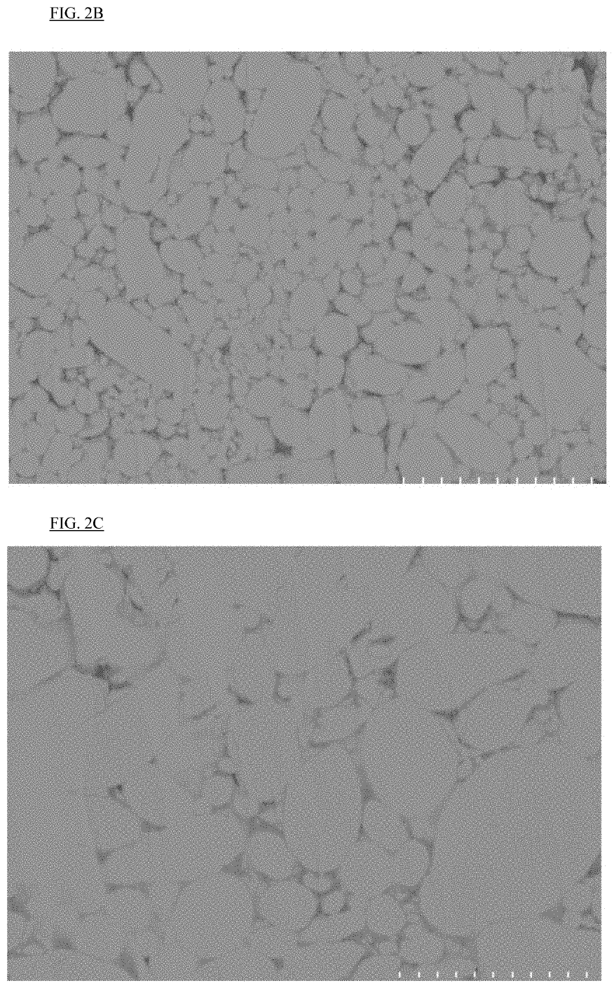

As shown in FIG. 2A, the soft magnetic molded body 12 of the magnetic core 10 according to this embodiment includes a plurality of soft magnetic alloy particles (soft magnetic particles) 21. In this embodiment, a region ranging from one adjacent soft magnetic alloy particle 21 to another adjacent soft magnetic alloy particle 21 is referred to as an intergranular region 31 of the soft magnetic alloy particles, and a region near the center of the particles 21 is referred to as an in-grain region. Note that, the center of the particles 21 is defined as the center of an inscribed circle of particles to be described later.

In this embodiment, each of the soft magnetic alloy particles 21 contains the element M and iron (Fe). Although not particularly limited, the soft magnetic alloy particle 21 according to this embodiment may also contain silicon (Si), carbon (C), or zinc (Zn) in addition to the components.

The element M has an ionization tendency greater than that of silicon (Si). In addition, the element M tends to form an oxide film on a surface of the soft magnetic alloy particle 21. Examples of the element M include chromium (Cr), aluminum (Al), magnesium (Mg), titanium (Ti), zirconium (Zr), manganese (Mn), and zinc (Zn), and chromium (Cr) or aluminum (Al) is preferable from the viewpoint of forming a uniform oxide film on iron alloy particles. In addition, as the element M, a plurality of elements may be used without limitation to one kind.

For example, in a case where the element M is chromium (Cr), a soft magnetic alloy composition (including both the particle 21 and the intergranular region 31 as shown in FIG. 2A/The same shall apply hereinafter) that constitutes the soft magnetic molded body 12 according to this embodiment contains 1% by mass to 9% by mass of chromium (Cr) in terms of Cr, and 0% by mass to 9% by mass of silicon (Si) in terms of Si, and the remainder is composed of iron (Fe). In addition, for example, in a case where the element M is aluminum (Al), the soft magnetic alloy composition that constitutes the soft magnetic molded body 12 according to this embodiment contains 1% by mass to 9% by mass of aluminum (Al) in terms of Al, and 0% by mass to 14% by mass of silicon (Si) in terms of Si, and the remainder is composed of iron (Fe).

The content of chromium (Cr) in the soft magnetic alloy composition is preferably 1% by mass to 9% by mass in terms of Cr, and more preferably 3% by mass to 7% by mass in terms of Cr.

The content of aluminum (Al) in the soft magnetic alloy composition according to this embodiment is preferably 1% by mass to 9% by mass in terms of Al, and more preferably 3% by mass to 7% by mass in terms of Al.

The content of silicon (Si) in the soft magnetic alloy composition according to this embodiment is preferably 0% by mass to 9% by mass in terms of Si, and more preferably 2% by mass to 8.5% by mass.

In the soft magnetic alloy composition according to this embodiment, the remainder may be substantially composed of only iron (Fe). The soft magnetic material composition according to this embodiment may also contain a component such as carbon (C) and zinc (Zn) in addition to the above-described constituent components.

In the soft magnetic material composition according to this embodiment, the content of carbon (C) is preferably less than 0.05% by mass, and more preferably 0.01% by mass to 0.04% by mass. In the soft magnetic material composition according to this embodiment, the content of zinc (Zn) is preferably 0.004% by mass to 0.2% by mass, and more preferably 0.01% by mass to 0.2% by mass. Note that, the soft magnetic material composition according to this embodiment may also contain unavoidable impurities in addition to the above-described components.

The intergranular region 31 according to this embodiment exists between the soft magnetic alloy particles 21 and is configured to cover an outer periphery of the soft magnetic alloy particles 21. In this embodiment, an amorphous phase may exist in the intergranular region 31. According to this, a low core loss can be accomplished. An Si-M oxide or an Si-M complex oxide that is an amorphous phase may exist in the intergranular region 31.

Note that, the Si-M oxide is an oxide that is mainly composed of silicon (Si), the element M, and oxygen (O). The Si-M oxide may also contain an element other than silicon (Si), the element M, and oxygen (O) in a total amount of less than 0.1% by mass with respect to 100% by mass, that is, the total mass of silicon (Si), the element M, and oxygen (O).

In addition, the Si-M complex oxide contains silicon (Si), the element M, and oxygen (O), and further contains an element other than the three components (Si, M, and O). Examples of the element other than the three components (Si, the element M, and O) contained in the Si-M oxide or the Si-M complex oxide include vanadium (V), nickel (Ni), or Copper (Cu).

In this embodiment, the intergranular region 31 may contain silicon (Si) that is not derived from elements contained in the soft magnetic alloy particle 21. Silicon (Si) that is not derived from the element contained in the soft magnetic alloy particle 21 is not particularly limited, but it is considered that the silicon is derived from silicon (Si) contained, for example, in a silicone resin that is used as a binder.

In this embodiment, a ratio (% by mass) M2 of the element M contained at a predetermined position O2 of the intergranular region 31 shown in FIG. 2A (an actual photomicrograph is shown in FIG. 5) is higher than a ratio (% by mass) M1 of the element M at the center O1 of the soft magnetic alloy particle 21 that is in contact with the intergranular region 31. For example, a proportional ratio M2/M1 is preferably 20 or more.

In addition, in this embodiment, the ratio (% by mass) M1 of the element M at the center O1 of the soft magnetic alloy particle 21 is within a range of 10% to 70% with respect to a ratio (% by mass) M0 of the element M in the soft magnetic composition that constitutes the soft magnetic molded body 12, preferably within a range of 10% to 50%, and more preferably within a range of 10% to 45%.

Further, a ratio S2 of Si contained at the predetermined position O2 of the intergranular region 31 may be higher or lower than the ratio S1 of Si at the center O1 of the soft magnetic alloy particle 21, but preferably higher than the ratio S1. For example, a proportional ratio S2/S1 is preferably 0.1 or more, and more preferably 3 or more.

The predetermined position O2 of the intergranular region 31 may be any position as long as the position is present on an inner side of the intergranular region 31, but for example, a position equidistant from two or three adjacent soft magnetic alloy particles 21 or the like is selected as a measurement position. In addition, the center O1 of the soft magnetic alloy particle 21 may be the center O1 of any soft magnetic alloy particle 21 adjacent to the intergranular region 31 that is measured.

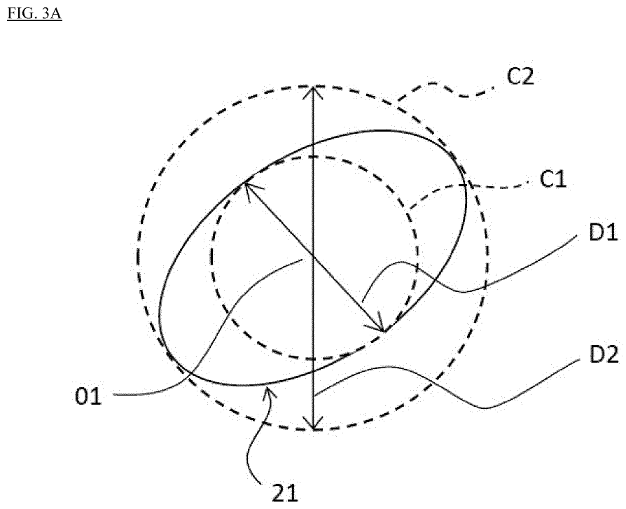

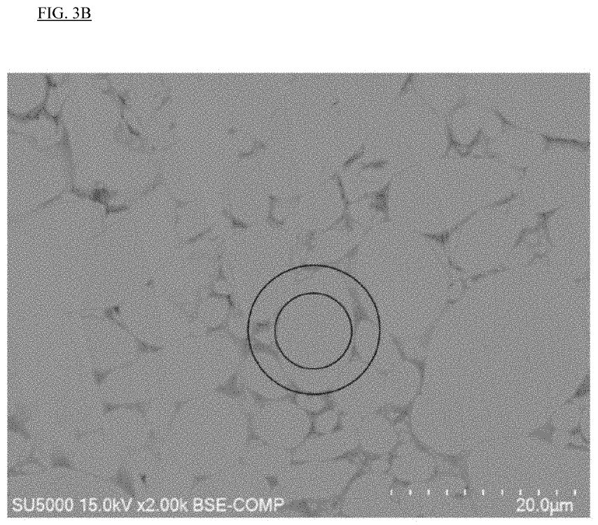

With regard to the center, for example, as shown in FIG. 3A (FIG. 3B), a virtual inscribed circle C1 and a virtual circumscribed circle C2 are drawn in conformity to a cross-sectional shape of the soft magnetic alloy particle 21 that is a measurement target, and the center of the inscribed circle C1 is set as the center O1 of the soft magnetic alloy particle 21. The inscribed circle C1 is defined as a circle having a maximum diameter D1 among inscribed circles which are in contact with a line indicating an outer edge of the particle 21, and the circumscribed circle C2 is defined as a circle having a minimum diameter D2 among circumscribed circles which are in contact with a line indicating an outer edge of the particle 21.

Note that, as shown in FIG. 2A (FIG. 5), with regard to a composition of the central position O1 of the soft magnetic alloy particle 21, and a composition of the predetermined position O2 of the intergranular region 31, for example, the compositions can be measured by performing EDS analysis by using an EDS device that is provided in an FE-SEM and has sufficiently high resolution. In addition, a ratio (% by mass) of the element M in the soft magnetic composition that constitutes the soft magnetic molded body 12 can be obtained, for example, as follows, and matches a ratio (% by mass) of the element M in a raw material composition that constitutes the soft magnetic molded body 12.

For example, a ratio (% by mass) of the element M in the soft magnetic composition that constitutes the soft magnetic molded body 12 is obtained by analyzing a crushed article corresponding to at least 10% by mass of a sample of the soft magnetic molded body 12 with a plasma emission analysis method by using an analyzer such as Ultima Expert (manufactured by HORIBA, Ltd.).

As shown in FIG. 2A, in this embodiment, on a cross-section of the soft magnetic molded body 12, an average of respective peripheral lengths of a plurality of the intergranular regions 31 existing at the periphery of the soft magnetic particles 21 is within a range of 5 μm to 15.5 μm, preferably a range of 5 μm to 15 μm, and more preferably a range of 5 μm to 12 μm. Calculation of the average of the peripheral lengths of the intergranular regions 31 can be performed as follows.

First, a cross-section of the soft magnetic molded body 12 is observed by using a field emission type scanning electron microscope (FE-SEM) to discriminate the soft magnetic alloy particles 21 and the region 31 between the soft magnetic alloy particles 21. Specifically, the cross-section of the soft magnetic molded body 12 is photographed by the FE-SEM to obtain a reflected electron image, for example, as shown in FIG. 2B or FIG. 2C.

In the reflected electron image, a region that exists between the soft magnetic alloy particles 21 and has contrast different from that of the soft magnetic alloy particles 21 is set as the intergranular region 31 between the soft magnetic alloy particles 21. Determination as to whether or not the region has different contrast may be made with naked eyes, or may be made by software that performs image processing. In FIG. 2B or FIG. 2C, a region that is observed in a particle shape and has high luminosity can be determined as the soft magnetic alloy particle 21, and a region that has low luminosity and is dark can be determined as the intergranular region 31.

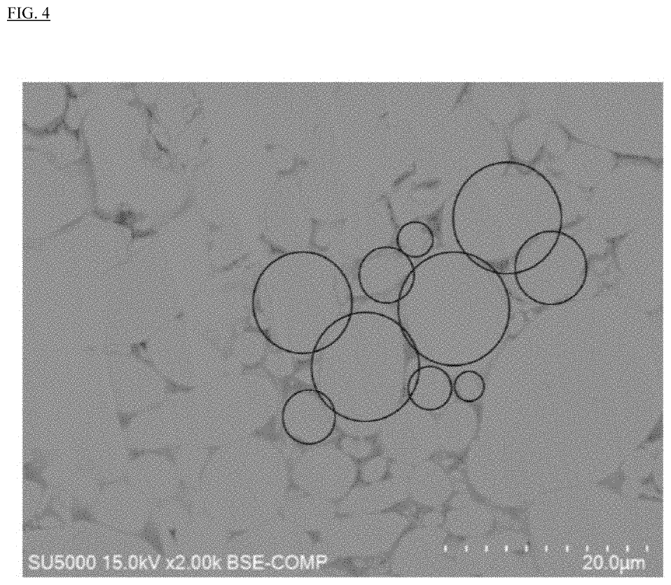

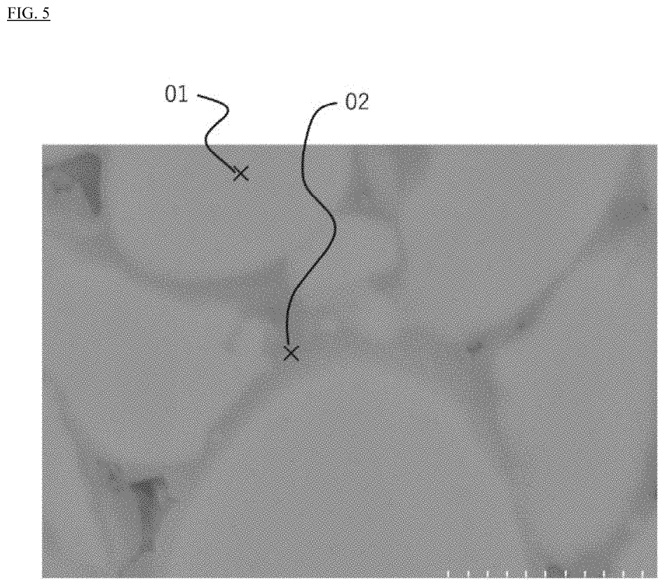

Next, for example, as shown in FIG. 4, in an observation range of a cross-section of the soft magnetic molded body 12 which is obtained by using the FE-SEM, 10 soft magnetic alloy particles 21 adjacent to each other on the cross-section are selected. The observation range of the cross-section of the soft magnetic molded body 12 which is obtained by using the FE-SEM is set to a range in which at least 10 or more soft magnetic alloy particles 21, and preferably 30 or more soft magnetic alloy particles 21 are observed.

In the observation range, with respect to the 10 soft magnetic alloy particles 21 adjacent to each other, peripheral lengths of individual particles 21 are calculated, and an average value thereof can be defined as an average of peripheral lengths of a plurality of the intergranular regions 31. The peripheral lengths of the individual particles 21 can be measured as follows. As shown in FIG. 3A, with respect to a cross-section of a selected particle 21, a virtual inscribed circle C1 and a virtual circumscribed circle C2 are drawn, and an average (ϕ×(D1+D2)/2) of a peripheral length (π×D1) of the inscribed circle C1 and a peripheral length (π×D2) of the circumscribed circle C2 can be measured as the peripheral length of each of the particles 21. The individual soft magnetic alloy particles 21 are covered with the intergranular regions 31 of which an average of the peripheral lengths is within a predetermined range.

In this embodiment, a width of a two-grain boundary intergranular region 31 interposed between only two particles 21 is preferably as thin as approximately 1 μm or less, and is preferably 0.01 to 0.3 μm. The width of the intergranular region 31 can be obtained as a maximum value of a width of a portion determined as the two-grain boundary intergranular region 31 interposed between only two particles 21 on a cross-section within an observation range of the soft magnetic molded body 12 which is obtained by using the FE-SEM. The width is a width between respective tangential lines of the two-grain boundary, and an intentionally and obliquely crossed width does not correspond to the width. In this embodiment, it is assumed that a triple-point intergranular region 31 surrounded by three particles 31 is not included in the definition of the width of the intergranular region 31.

A coating layer may be formed on the surface of the soft magnetic molded body 12 of this embodiment. A material of the coating layer is not particularly limited, and examples thereof include a glass composition, SiO₂, B₂O₃, ZrO₂, a resin, and the like. Note that, the coating layer may be composed of a plurality of materials, or may have a stacked structure including a plurality of layers. For example, the coating layer may be formed on at least a part of the surface of the soft magnetic molded body 12.

Next, an example of a manufacturing method of the soft magnetic molded body 12 according to this embodiment will be described.

The soft magnetic molded body 12 according to this embodiment can be prepared by heat-treating a pressure-molded body including a soft magnetic alloy powder and a binder (a binder resin). Hereinafter, a preferred manufacturing method of a core of this embodiment will be described in detail.

In the manufacturing method according to this embodiment, first, the soft magnetic alloy powder and the binder are mixed to obtain a mixture. Next, the mixture is dried to form a granulated powder. Next, the mixture or the granulated powder is formed in a shape of the soft magnetic molded body 12 to be prepared, thereby obtaining a preliminary molded body. Then, the obtained preliminary molded body is subjected to a heat treatment to obtain a soft magnetic molded body.

An alloy powder that can be used as the soft magnetic alloy powder contains 1% by mass to 9% by mass of chromium (Cr) in terms of Cr, and 0% by mass to 9% by mass of silicon (Si) in terms of Si, the remainder is composed of iron (Fe). A shape of the soft magnetic alloy powder is not particularly limited, but a spherical shape or an elliptical shape is preferable from the viewpoint of maintaining inductance up to a high magnetic field region. Among these, the elliptical shape is preferable from the viewpoint of further enlarging the strength of a core. In addition, an average particle size of the soft magnetic alloy powder is preferably 1 to 8 μm, and more preferably 2 to 5 μm.

The soft magnetic alloy powder can be obtained by a similar method as in a method of preparing a known soft magnetic alloy powder. At this time, a gas atomization method, a water atomization method, a rotary disc method, or the like can be used in preparation. Among these, the water atomization method is preferable in order for a soft magnetic alloy powder having desired magnetic characteristics to be easily prepared.

As the binder, an epoxy resin, a silicone resin, a phenolic resin, water glass, or the like is used, but the silicone resin is preferably used. When using the silicone resin as the binder, silicon (Si) that is not derived from elements contained in the soft magnetic alloy particle 21 is effectively contained in the intergranular region 31 of the soft magnetic alloy particles 21. As a result, an amorphous phase is likely to be formed in the region 31 between the soft magnetic alloy particles 21. An addition amount of the binder is different in correspondence with required core characteristics, but 0.2% by mass to 10% by mass of binder can be preferably added with respect to 100% by mass of soft magnetic alloy powder.

In addition, an organic solvent may be added to the mixture or the granulated powder as necessary within a range not deteriorating the effect of the present invention. The organic solvent is not particularly limited as long as the organic solvent can dissolve the binder, and examples thereof include various solvents such as toluene, isopropyl alcohol, acetone, methyl ethyl ketone, chloroform, and ethyl acetate. In addition, various additives, a lubricant, a plasticizer, a thixotropic agent, or the like can be added to the mixture or the granulated powder as necessary.

A method of obtaining the mixture is not particularly limited, but the mixture is obtained by mixing the soft magnetic alloy powder, the binder, and the organic solvent by a known method in the related art. Note that, various additives can be added as necessary. In mixing, for example, a mixer such as a pressure kneader, an attritor, a vibration mill, a ball mill, and a V mixer, or a granulator such as a fluidized granulator and a tumbling granulator can be used. In addition, a mixing temperature and a mixing time are preferably set to room temperature and approximately 1 to 30 minutes.

A method of obtaining the granulated powder is not particularly limited, and the granulated powder is obtained by drying the mixture by a known method. A drying temperature and a drying time are preferably set to room temperature to approximately 200° C., and 1 to 60 minutes. A lubricant can be added to the granulated powder as necessary. After adding the lubricant to the granulated powder, mixing is preferably performed for 1 to 60 minutes.

A method of obtaining the preliminary molded body is not particularly limited, and it is preferable that a molding mold including a cavity having a desired shape is used, the cavity is filled with the mixture or the granulated powder, and the mixture is compression-molded at a predetermined molding temperature and a predetermined molding pressure in accordance with a known method.

Molding conditions in the compression molding are not particularly limited, and may be appropriately determined in correspondence with a shape and dimensions of the soft magnetic alloy powder, a shape, dimension, and a density of the magnetic core, and the like. For example, typically, a maximum pressure is set to approximately 100 to 1000 MPa, and preferably approximately 400 to 800 MPa, and a holding time at the maximum pressure is set to approximately 0.5 seconds to 1 minute. A molding temperature is not particularly limited, but typically, approximately room temperature to 200° C. is preferable.

Next, the molded body obtained after molding is subjected to a heat treatment to obtain a soft magnetic molded body (heat treatment step). A holding temperature in the heat treatment step is not particularly limited, but typically, approximately 600° C. to 900° C. is preferable. A temperature increase rate in the heat treatment step is not particularly limited, but it is preferable to reach the holding temperature within a short time after initiating heating of the molded body. Specifically, it is preferable to raise an actual temperature near a preliminary molded body in a furnace at a rate within a range of 5° C. to 50° C./minute.

The heating method in the heat treatment step is not particularly limited, but for example, 500 g of preliminary molded body is stacked in a single layer in an area of 1 square meter, and a temperature is preferably raised up to a highest holding temperature at a rate of 8° C./minute or higher.

An atmosphere in the heat treatment step is not particularly limited, but the heat treatment step is preferably performed in an oxygen-containing atmosphere. Here, the oxygen-containing atmosphere is not particularly limited, but examples thereof include an atmospheric atmosphere (typically, containing 20.95% of oxygen), a mixed atmosphere with an inert gas such as argon and nitrogen, and the like. Note that, the heat treatment step may be performed in an inert gas atmosphere such as argon and nitrogen.

Next, a coating layer before heat treatment which is composed of a glass composition, a binder resin, or the like is formed on a surface of the obtained soft magnetic molded body as necessary. The soft magnetic molded body 12 that is obtained as described above can be used as the magnetic core 10.

In this embodiment, the ratio of the element M at the center O1 of the soft magnetic alloy particle 21 shown in FIG. 2A is within a specific range, and the peripheral length of the intergranular region 31 of the soft magnetic alloy particle 21 is within a specific range. In the soft magnetic molded body 12 of this embodiment, the DC bias characteristics can be improved. In addition, a chipping rate can also be reduced, a defect rate during manufacturing can be reduced, and impact resistance during use is improved. Further, in the soft magnetic molded body 12 of this embodiment, a withstand voltage, insulation resistance, and bending strength are also improved.

Applications of the soft magnetic molded body according to this embodiment are not particularly limited, and the soft magnetic molded body is used, for example, as a magnetic core or the like, and can be preferably used as a part of various electronic components such as an inductor, a transformer, a choke coil, a witching power supply, a DC-DC converter, a noise filter, and a reactor.

Note that, the present invention is not limited to the above-described embodiment, and can be modified in various ways.

For example, in the above-described embodiment, the mixture or the granulated powder is compacted to manufacture a magnetic core composed of the soft magnetic molded body, but the mixture may be molded in a sheet shape to manufacture the soft magnetic molded body, and the soft magnetic molded body may be stacked to manufacture a magnetic core. In addition, the preliminary molded body before heat treatment may be obtained by wet molding, extrusion molding, or the like in addition to dry molding.

In the above-described embodiment, the silicone resin is used as the binder so as to form a layer containing silicon (Si) at a grain boundary of the soft magnetic material composition, but silicon (Si)-containing components such as silica gel and silica particles may be used as an additive instead of the silicon resin.

### EXAMPLE

Hereinafter, Examples of the present invention will be described in detail, but the present invention is not limited to Examples.

### Example 1

[Preparation of Soft Magnetic Alloy Powder]

Ingots, chunks (lumps), or shots (particles) of an iron (Fe) elementary substance, a chromium (Cr) elementary substance, and a silicon (Si) elementary substance were prepared. Next, these were mixed to have a composition containing 4% by mass of chromium (Cr), 5% by mass silicon (Si), and the remainder composed of iron (Fe), and the resultant mixture was accommodated in a crucible disposed in a water atomization device. Next, the crucible was heated to 1600° C. higher through high-frequency induction by using a work coil provided on an outer side of the crucible in an inert atmosphere to melt and mix the ingots, the chunks, or the shots in the crucible, thereby obtaining a melt.

Next, the melt in the crucible was ejected from a nozzle provided in the crucible, and a high-pressure (50 MPa) water stream was caused to collide with the ejected melt to rapidly cool down the melt, thereby manufacturing a soft magnetic alloy powder (average particle size: 4 μm) composed of Fe—Si—Cr based particles.

[Preparation of Soft Magnetic Molded Body]

4% by mass of silicone resin (SR2414LV, manufactured by Dow Corning Toray Silicone Co., Ltd.) was added to 100% by mass of obtained soft magnetic alloy powder, and the resultant mixture was mixed at room temperature for 30 minutes by using a pressure kneader. Next, the mixture was dried at 150° C. for 20 minutes in the air. Zinc stearate (manufactured by Nitto Kasei Co., Ltd.) as a lubricant was added to the soft magnetic alloy powder after drying, and the resultant mixture was mixed for 10 minutes by a V mixer. The amount of zinc stearate added was 0.5% by mass with respect to 100% by mass of soft magnetic alloy powder.

Next, the obtained mixture was molded into a toroidal sample having dimensions of 18 mm (outer diameter)×10 mm (inner diameter)×5 mm (thickness), thereby preparing a preliminary molded body. Note that, a molding pressure was set to 600 MPa.

500 g of preliminary molded body was stacked in a single layer in an area of 1 square meter, a temperature was raised up to a highest holding temperature at a rate of 8° C./minute or higher, the preliminary molded body was held at a holding temperature of 700° C. to 800° C. for 60 minutes in the air, thereby obtaining the soft magnetic molded body 12. With respect to a sample of the soft magnetic molded body 12 having a toroidal shape, composition analysis was performed by the above-described method, and from the composition analysis of the soft magnetic molded body 12, it could be confirmed that the composition matches a composition of a raw material powder. A ratio M0 of Cr as the element M in the soft magnetic alloy composition that constitutes the soft magnetic molded body 12 was 4% by mass when the sum of Fe, Cr, O, and Si was set to 100% by mass.

In addition, a part of the sample of the soft magnetic molded body 12 having the toroidal shape was cut out, the cross-section was observed with a field emission type scanning electron microscope (FE-SEM), and “soft magnetic alloy particle 21” and “intergranular region 31 between soft magnetic alloy particles” were discriminated as shown in FIG. 2A.

Next, with respect to the center O1 of 10 soft magnetic alloy particles 21 adjacent to each other in the cross-sectional photograph, EDS analysis was performed by using an EDS device, “% by mass” of Cr as the element M was obtained when the sum of Fe, Cr, O, and Si was set to 100% by mass, and an average thereof was obtained. The average value was set as a ratio (% by mass) M1 of the element M (Cr) at the center O1 of the soft magnetic alloy particle 21. A percentage notation of a value (M1/M0) obtained by dividing the ratio (% by mass) M1 of the element M by the ratio M0 of the element M (Cr) in the above-described composition was shown in Table 1.

In addition, composition analysis of Fe, Cr, 0, and Si was performed at the center O1 of the 10 soft magnetic alloy particles 21 adjacent to each other in the cross-sectional photograph and a predetermined position O2 at arbitrary 10 points of the intergranular region 31 surrounding the particles 21. Results are shown in Table 2.

In addition, the following measurement was performed with respect to the sample of the soft magnetic molded body 12 having the toroidal shape.

<DC Bias Characteristics: Idc10A>

A copper wire was wound around the sample of the soft magnetic molded body 12 having the toroidal shape by 20 turns, and permeability μ1 when applying a DC current of 10 A was measured by using LCR meter (4284A, manufactured by Hewlett-Packard Company). As measurement conditions, a measurement frequency was set to 1 MHz, and a measurement temperature was set to 25° C. 100×μ1/μ0 (%) was obtained from an obtained measurement value, and was set to correspond to Hdc4.9 A/m. Note that, μ0 was permeability before applying a DC current. Results are shown in Table 1.

<Chipping Rate>

A chipping rate was obtained by the following method. With respect to three samples, a total weight (W1) before test was measured. Next, the three samples were put into a pot (ratra tester) that includes an internal baffle and has a diameter of approximately 10 cm. Then, the three samples were rolled in the pot at a rotation speed of 100 rpm for a rotation time of 10 minutes. Then, the weight (W2) of the three samples after termination of the test was measured. A weight reduction rate of the three samples before and after the test was obtained, and this was set as a chipping rate. That is, the chipping rate (%) was calculated by the following Expression (1).

Chipping rate (%)=100×(W1−W2)/W1 Expression (1)

### Comparative Example 1

A sample of the soft magnetic molded body 12 having the toroidal shape was manufactured in a similar manner as in Example 1 except that a raw material powder in which an average particle size of the soft magnetic alloy powder composed of Fe—Si—Cr based particles is small was used, and as the heat treatment conditions, the temperature increase rate was changed to 2° C./minute so as to change the peripheral length and M1/M0 to values shown in Table 1, and the same measurement was performed. Results are shown in Table 1.

### Examples 2 and 5, and Comparative Examples 2 to 6

A sample of the soft magnetic molded body 12 having the toroidal shape was manufactured in a similar manner as in Example 1 except that a raw material powder in which an average particle size of the soft magnetic alloy powder composed of Fe—Si—Cr based particles is gradually large was used so as to change the peripheral length and M1/M0 to values shown in Table 1, and the same measurement was performed. Results are shown in Table 1. Note that, an FE-SEM image in Example 5 is shown in FIG. 2B and FIG. 5, and an FE-SEM image in Comparative Example 3 is shown in FIG. 2C, FIG. 3B, and FIG. 4.

### Example 3

A sample of the soft magnetic molded body 12 having the toroidal shape was manufactured in a similar manner as in Example 2 except that Al was used instead of Cr as the element M, and the same measurement was performed. Results are shown in Table 1.

### Example 4

A sample of the soft magnetic molded body 12 having the toroidal shape was manufactured in a similar manner as in Example 2 except that an epoxy resin was used instead of the silicone resin, and the same measurement was performed. Results are shown in Table 1 and Table 2.

### Various Evaluations

In the samples of the respective Examples in which the peripheral length and M1/M0 are within a predetermined range as shown in Table 1, it was confirmed that the DC bias characteristics are excellent, and the chipping rate is low. In addition, in Examples, it could be confirmed that the bending strength, the withstand voltage, and the insulation resistance are also satisfactory.

That is, it could be confirmed that the soft magnetic molded bodies of Examples can be preferably used in a magnetic core, an electronic component using the magnetic core, and the like. Note that, Idc10A is preferably 90 or more, and more preferably 91 or more, 92 or more, 93 or more, and 95 or more in this order. In addition, the chipping rate is preferably 0.20 or less, and more preferably 0.19 or less.

TABLE 1

| Examples/ | Element M | | Peripheral | M1/ | | Idc 10A | Chipping |
|---|---|---|---|---|---|---|---|
| Comparative | in raw | | length | M0 | | μ retention rate (%) | rate |
| Examples | material | Resin | (μm) | (%) | μ | (DC superimposition) | (%) |
| Comparative | Cr | Silicone | 3.2 | 9.1 | 22.3 | 98.9 | 0.23 |
| Example 1 | | | | | | | |
| Example 1 | Cr | Silicone | 5.3 | 10.3 | 23.7 | 97.4 | 0.19 |
| Example 4 | Cr | Epoxy | 11.4 | 38.7 | 24.0 | 94.0 | 0.18 |
| Example 3 | Al | Silicone | 11.5 | 39.7 | 24.9 | 93.8 | 0.18 |
| Example 2 | Cr | Silicone | 11.6 | 40.0 | 27.9 | 93.2 | 0.18 |
| Example 5 | Cr | Silicone | 15.2 | 68.8 | 32.1 | 90.3 | 0.18 |
| Comparative | Cr | Silicone | 17.9 | 73.8 | 34.6 | 87.1 | 0.15 |
| Example 2 | | | | | | | |
| Comparative | Cr | Silicone | 25.2 | 80.8 | 40.2 | 83.0 | 0.15 |
| Example 3 | | | | | | | |
| Comparative | Cr | Silicone | 32.6 | 83.2 | 45.1 | 77.1 | 0.13 |
| Example 4 | | | | | | | |
| Comparative | Cr | Silicone | 64.2 | 84.6 | 65.3 | 53.7 | 0.10 |
| Example 5 | | | | | | | |
| Comparative | Cr | Silicone | 106.2 | 86.1 | 92.0 | 22.6 | 0.09 |
| Example 6 | | | | | | | |

TABLE 2

| | EDS point analysis | | | |
|---|---|---|---|---|
| | Example 1 | | Example 4 | |
| (% by | In-grain | Intergranular | In-grain | Intergranular |
| mass) | center O1 | region O2 | center O1 | region O2 |
| O | 0 | 44 | 0 | 31 |
| Si | 8 | 35 | 7 | 1 |
| Cr | 0.4 | 20 | 0.4 | 67 |
| Fe | 91.6 | 1 | 93.6 | 1 |

### EXPLANATIONS OF LETTERS OR NUMERALS

10 MAGNETIC CORE
21 SOFT MAGNETIC ALLOY PARTICLE (SOFT MAGNETIC PARTICLE)
31 INTERGRANULAR REGION

What is claimed is:

1. A soft magnetic body comprising:
soft magnetic particles containing an element M; and
an intergranular region existing between the soft magnetic particles and covering the soft magnetic particles,
wherein a ratio of the element M at the center of the soft magnetic particles to a ratio of the element M in a soft magnetic composition that constitutes the soft magnetic body is within a range of 10% to 70% on a cross-section of the soft magnetic body, and
an average of peripheral lengths of the intergranular regions existing around each of the soft magnetic particles is within a range of 5 μm to 15.5 μm on the cross-section of the soft magnetic body.

2. The soft magnetic body according to claim 1,
wherein the element M contains at least one or more elements of which ionization tendency is larger than ionization tendency of Fe and Si.

3. The soft magnetic body according to claim 1,
wherein a ratio of the element M contained in the intergranular regions is higher than a ratio of the element M at the center of the soft magnetic particles.

4. The soft magnetic body according to claim 1,
wherein a ratio of Si contained in the intergranular regions is higher than a ratio of Si at the center of the soft magnetic particles.

5. A magnetic core, comprising:
the soft magnetic body according to claim 1.

6. An electronic component, comprising:
the soft magnetic body according to claim 1.
